(19) United States
(12) Patent Application Publication
(10) Pub. No.: US 2005/0204897 A1
(43) Pub. Date: Sep. 22, 2005

(54) Tuner for musical instruments integrated with utility device and method therefor

(76) Inventors: Charles C. Adams, Gilbert, AZ (US); Mark D. Van Vleet, Scottsdale, AZ (US); Richard H. Fliegler, Fountain Hills, AZ (US); Dale V. Curtis, Scottsdale, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/802,893

(22) Filed: Mar. 16, 2004

(51) Int. Cl. G10G 7/02

(52) U.S. Cl. 84/454

(57) ABSTRACT

A tuning device (30) uses a stroboscopic light source for tuning musical instruments (12). The stroboscopic light source is programmable according to the musical instrument being tuned. A first control button (34) on the tuner programs the stroboscopic light source. A second control button (36) enables the stroboscopic light source. A display (38) indicates the state of the stroboscopic light source. A utility device (32) is integrated with the tuner. The utility device can be a key ring, lighter, utility tool, pin light, cell phone, card, watch, or jewelry. The utility device has a secondary function, which is independent and apart from the tuning activity associated with the musical instrument. The second function of the utility device provides convenience, accessibility, and increases the likelihood that the user will have the tuning device available when needed.

### FIELD OF THE INVENTION

The present invention relates in general to musical instrument tuners, more particularly, to a portable utility device with integrated tuner for tuning musical instruments.

### BACKGROUND OF THE INVENTION

Musical instruments have always been very popular in society providing entertainment, social interaction, self-expression, and a business and source of livelihood for many people. String instruments are especially popular because of their active playability, tonal properties, and portability. String instruments are fun and yet challenging to play, have great sound qualities, and are easy to move about from one location to another.

Guitars are one type of string musical instrument. The musical artist or user plays the guitar by using his or her fingers or a guitar pick to displace one or more of the tightly strung strings from their neutral position and then releasing, causing the string to vibrate as it returns to its neutral position. The pick offers certain advantages in terms of sharpness of the string vibration and clarity of the note played.

A guitar has a certain number of strings, e.g. five or six strings, which are tightly strung between a bridge and neck assembly. One end of each guitar string is typically firmly attached or held to the bridge. The other end of the strings is respectively attached to geared machine heads on the head stock assembly, which is used to tighten and loosen the tension on each string.

The string tension is very important to the performance of the guitar. Each string of the guitar is designed to resonate with a specific frequency. Given the resonant frequency of each string, the guitar player presses his or her fingertips of the off-hand on different locations of the strings on the fret board to produce different musical notes. If the string tension is not properly adjusted, then the base resonant frequency of the string is off and the notes as played will not sound right. The guitar is considered out-of-tune and will not play as intended or designed.

A variety of tuning techniques have been devised over the years to set the proper string tension on each guitar string. It is known to use a stroboscopic light source to tune the guitar by adjusting the individual string tensions. In normal light, when the string is plucked, it appears to vibrate at a given frequency. Under the stroboscopic light, when the string is plucked it appears to move at a slower rate as determined by the beat frequency or difference between the strobe light frequency and the resonant frequency of the given string under its present string tension. The tuning process involves adjusting the tension until the string appears as a standing wave in the strobe light, i.e., until no string movement is detected under the strobe light.

Most strobe-based tuners are bulky, dedicated units; designed primarily for use in manufacturing facilities and repair shops. Some tuners require special tools to accurately tune the instrument. While the guitar can be accurately tuned while in the hands of the skilled guitar maker or repair technician, the instrument can become de-tuned in short order with normal use, and particularly so with certain aggressive playing styles. The special tuning tools and tuning processes, and the skill and knowledge necessary to properly use them, are not available or convenient for everyday or routine re-tuning.

Portable tuners as dedicated units for string instruments have been used for some time. However, the portable tuning units are not always convenient or necessarily available when the need arises. The artist may not have brought the portable tuner along to the playing session. The portable tuner is often viewed as one more piece of ancillary equipment to pack around. Thus, the known dedicated portable tuners are not convenient or always accessible.

To make the tuner more convenient and accessible for the playing artist during routine use, some stroboscopic tuners have been integrated into the guitar body itself. The tuner strobe light source has been mounted to the soundboard or under the strings. Guitar-mounted stroboscopic tuners add weight to the guitar and may impact its playing performance. Moreover, the guitar-mounted tuner adds cost and manufacturing complexity to the instrument.

A need exists for a tuner that is convenient and accessible and can tune musical instruments on a routine basis in everyday settings.

### SUMMARY OF THE INVENTION

In one embodiment, the present invention is a tuning device for a musical instrument comprising a tuner having a programmable stroboscopic light source adapted for tuning a musical instrument. A control button on the tuner programs a state of the stroboscopic light source. A utility device is integrated with the tuner. The utility device has a secondary function that is independent of the tuning activity associated with the musical instrument.

In another embodiment, the present invention is a musical instrument-tuning device comprising a tuner. A utility device is integrated with the tuner. The utility device has a secondary function apart from the musical instrument.

In yet another embodiment, the present invention is a method of making a portable musical instrument tuner comprising the steps of providing a tuner, and providing a utility device integrated with the tuner, wherein the utility device has a secondary function apart from the tuner.

### BRIEF DESCRIPTION OF THE DRAWINGS

FIG. 1 illustrates a guitar as one type of musical instrument;

FIG. 2 illustrates a key ring with an integrated stroboscopic tuner;

FIG. 3 illustrates a utility device with integrated stroboscopic tuner directed to guitar strings;

FIG. 4 is a block diagram of electronic control circuit and stroboscopic light source;

FIG. 5 illustrates a lighter with an integrated stroboscopic tuner;

FIG. 6 illustrates a utility tool with an integrated stroboscopic tuner;

FIG. 7 illustrates a watch with an integrated stroboscopic tuner;

FIG. 8 illustrates a pin light with an integrated stroboscopic tuner;

FIG. 9 illustrates a cell phone with an integrated stroboscopic tuner;

FIG. 10 illustrates a plastic card with an integrated stroboscopic tuner;

FIG. 11 illustrates a plastic card with an integrated stroboscopic tuner having multiple light sources;

FIG. 12 is a block diagram of the electronic control circuit receiving audio input and driving multiple stroboscopic light sources; and

FIG. 13 is a block diagram of an audio tuner.

### DETAILED DESCRIPTION OF THE DRAWINGS

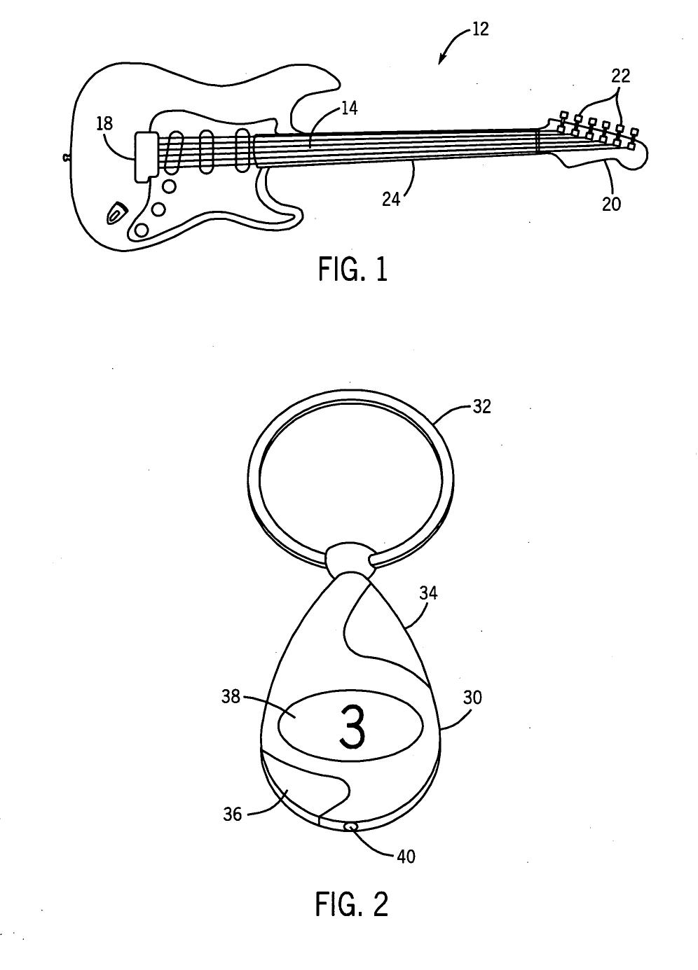

Referring to FIG. 1, a musical instrument is shown as guitar 12. There are many types and configurations of guitars including electric, electric bass, and acoustic styles. Other types of musical string instruments include the mandolin, viola, and violin. Each type of musical instrument has a number of strings running across the frame of the instrument. The musical artist plays the instrument by displacing one or more of the tightly strung strings from their neutral position and then releasing, causing the string to vibrate as it returns to its neutral position. The string vibration emits different sounds depending on the type of instrument and skill of the musician.

Other types of musical instruments that require tuning include keyboards, percussion, horns, and the like. Each of these instruments emits audible sound and requires adjustment from time to time for optimal performance.

In the case of guitar 12, a plurality of strings 14 are routed from bridge 18 across the body or soundboard to head stock assembly 20. Guitar 12 may have five or six strings which are tightly strung between bridge 18 and head stock assembly 20. One end of each guitar string 14 is firmly attached or held to bridge 18. The other ends of strings 14 are attached to respective machine heads 22 on head stock assembly 20. Machine heads 22 are geared and can be rotated or turned to increase or decrease the tension on strings 14.

The string tension is very important to the performance of the guitar. Guitar 12 is designed such that each string 14 resonates at a specific frequency. Given the resonant frequency of each string, the guitar player presses his or her fingertips of the off-hand on different locations of strings 14 on fret board 24 to produce different musical notes. If the string tension is not properly adjusted, then the base resonant frequency of the string is off and the note played will not sound right. The guitar is considered out-of-tune and will not play as intended or designed.

For a given type of string, the string tension determines, to a significant degree, the resonant frequency of that string. Machine heads 22 are a primary string tension adjustment available to the artist or technician. Turning machine head 22 in one direction, e.g., clockwise, increases the string tension; turning machine head 22 in the other direction, e.g., counter-clockwise, reduces the string tension. The correct string tension is a fundamental precursor and requirement to maintaining guitar 12 in its proper tuned state or condition.

Guitar strings 14 can lose their correct tension in normal play and even more readily become out-of-tune when the instrument is played in an aggressive manner. The artist may find guitar 12 looses optimal string tension over the course of a playing session or performance and even between and during individual musical pieces. The artist typically does not have the time or opportunity to have the guitar professionally re-tuned in such settings. Most portable tuners are inconvenient to carry around and may not be available when needed. Accordingly, in the past, the artist has just made best efforts to re-adjust the string tension by ear or feel alone. The artist turns machine heads 22 until the instrument sounds or feels as good as it's going to get at the time, and awaits the next time that the instrument is in the repair shop or technician's bench for a thorough and proper re-tune.

To aid the artist in re-tuning guitar 12 in many everyday situations, a portable tuner 30 using a stroboscopic light source is shown in FIG. 2. Tuner 30 is integrated with a common, ordinary utility device that has secondary utility or function. In the present example, the common, ordinary utility device shown in FIG. 2 is key ring 32. Key ring 32 is integrated with tuner 30 by nature of key ring 32 looping through an eyelet attachment of tuner 30. The secondary utility or function of key ring 32 is to organize and carry keys. The keys provide access to ordinary, everyday items such as automobiles, houses, padlocks, office, and the like. The artist is likely to carry key ring 32 on his or her person and therefore have tuner 30 convenient and accessible in most daily situations.

Tuner 30 is formed with an attractive shape that is easy to hold and operate. The form factor of tuner 30 is stylistic and functional. In FIG. 2, tuner 30 has a tear-drop shape and is made with metal or plastic. In other packaging styles, the form factor of tuner 30 may be circular, rectangular, cylindrical, and any other shape that is readily held and can be directed as a light source. Tuner 30 includes control button 34 and control button 36. Button 34 sets the tuning frequency. Button 36 enables the stroboscopic light source. Display 38 is positioned on a surface of tuner 30 and displays information related to the tuning frequency. Lens 40 emits the stroboscopic light when enabled by button 36.

Consider the situation where guitar 12 requires re-tuning. The situation may arise in a practice setting or during a performance. During a break in the action, the artist reaches for key ring 32 and tuner 30. Tuner 30 is readily available because it is part of a utility item or device, e.g., key ring 32, that the artist is likely to have with him or her, independent of the fact that they are presently in a playing session with guitar 12. The secondary utility of key ring 32 offers convenience, accessibility, and increases the likelihood that it will be generally available, including in situations where the stroboscopic tuner attachment is needed. In this case, the artist reaches into his or her pocket or purse and produces key ring 32 with integrated tuner 30.

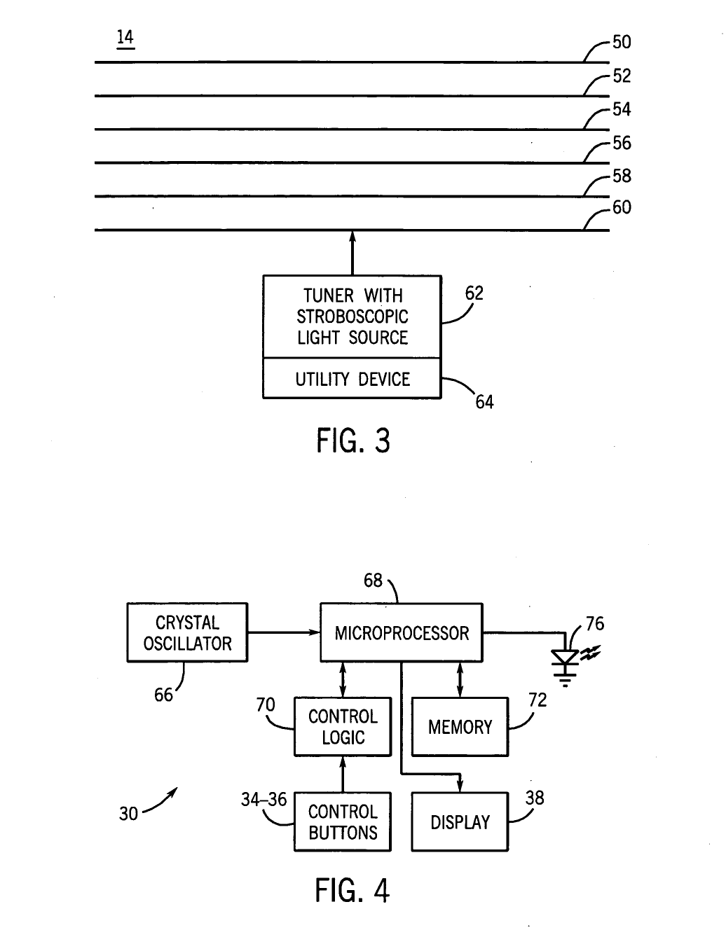

Tuner 30 produces a stroboscopic light that operates at several different frequencies. Button 34 changes the strobe frequency, and button 36 enables the stroboscopic light source at the given strobe frequency. FIG. 3 generally illustrates utility device 64 integrated with tuner 62 having stroboscopic light source. The stroboscopic light is illuminated on the strings 50-60 of guitar 12 as shown in FIG. 3. The stroboscopic light operating at different specific frequencies allows the artist to tune guitar 12. String 50 is tuned to an E note and has a resonant frequency of 82.4 Hz; string 52 is tuned to an A note and has a resonant frequency of 110 Hz; string 54 is tuned to a D note and has a resonant frequency of 146.83 Hz; string 56 is tuned to a G note and has a resonant frequency of 195.99 Hz; string 58 is tuned to a B note and has a resonant frequency of 246.94 Hz; string 60 is tuned to an E note and has a resonant frequency of 329.62 Hz.

The present strobe frequency is displayed on display 38 with a number, letter, or other indicator of the programmed frequency. In the present example, the artist presses control button 34 to select strobe frequency number “1” which corresponds to 82.4 Hz. The artist presses control button 36 to activate the stroboscopic light source operating at the programmed frequency of 82.4 Hz. The strobe light emitting from tuner 30 is directed onto string 50 of guitar 12. String 50 is plucked and the associated machine head 22 is adjusted until the string is viewed as stationary in the strobe light. When the vibrating string 50 is viewed as motionless in the strobe light, the tension of string 50 has been re-tuned to the property resonant frequency.

If necessary, the artist presses control button 34 again, this time to select strobe frequency number “2” which corresponds to 110 Hz. The artist presses control button 36 to activate the stroboscopic light source operating at the programmed frequency of 110 Hz. The strobe light emitting from tuner 30 is directed onto string 52 of guitar 12. The string 52 is plucked and the associated machine head 22 is adjusted until the string is viewed as stationary in the strobe light. When the vibrating string 52 is viewed as motionless in the strobe light, the tension of string 52 has been re-tuned to the property resonant frequency.

The artist may press control button 34 to select strobe frequency number “3” which corresponds to 146.83 Hz for string 54 of guitar 12, or strobe frequency number “4” which corresponds to 195.99 Hz for string 56, or strobe frequency number “5” which corresponds to 246.94 Hz for string 58, or strobe frequency number “6” which corresponds to 329.62 Hz for string 60. The process continues as necessary until all strings 50-60 of guitar 12 are properly re-tuned to the property resonant frequency.

When selecting the stroboscopic tuning frequency, the letters “A”, “B”, “C”, etc., can be displayed, or the letter corresponding to the musical note that is associated with the individual string is displayed. In a six-string guitar, the letters are “E”, “B”, “G”, “D”, “A”, and “E”. In another embodiment, the actual numeric tuning frequency, e.g., 82.4 Hz, 110 Hz, 146.83 Hz, 195.99 Hz, 246.94 Hz, 329.62 Hz, is displayed.

Tuner 30 can be programmed with a variety of settings useful with different string instruments and tonal qualities. For example, tuner 30 can be programmed for specific guitars, specific notes, sharp/flat capability, and the like. Additional control buttons can be provided to select between a menu of tuning options and capabilities. The menu is viewed on display 38.

The key ring 32 with integrated tuner 30 may have additional secondary utilities or functions. For example, tuner 30 may have a high power mode to function as a flashlight. Control button 34 can be pressed to select flashlight mode, indicated as number “0” on display 38, or with the word “light”. Pressing control button 36 produces a continuous light from lens 40 with sufficient brightness to view close-up objects in low-light settings. In another embodiment, the flashlight mode is selected with a separate control button on a surface of tuner 30. Another utility function can be remote keyless entry within the housing of tuner 30. Additional control buttons would be provided on the face of tuner 30 for the remote keyless entry options, such as lock door, unlock door, unlock trunk, and panic button.

Further detail of the electronic components of tuner 30 is shown in FIG. 4. Crystal oscillator 66 generates a stable, reliable clock signal having a known frequency and duty cycle. Microprocessor 68 receives the clock signal from oscillator 66. Control buttons 34 and 36 are coupled to control logic 70, which provides the appropriate programming control signal to microprocessor 68. Control button 34 selects the tuning mode and control button 36 enables the stroboscopic light. The stroboscopic frequency is displayed on display 38. Microprocessor 68 retrieves the tuning modes from memory 72 based on the programming control signal from control logic 70. Microprocessor 68 divides the clock signal based on the tuning mode and provides a control signal which enables and disables light emitting diode (LED) 76 to generate the strobe light through lens 40. In one tuning mode based on control input from button 34, microprocessor 68 controls LED 76 to generate a stroboscopic light at 82.4 Hz. In another tuning mode, microprocessor 68 controls LED 76 to generate a stroboscopic light at 110 Hz. In other embodiments, hard-wired control logic can be used for the function of microprocessor 68.

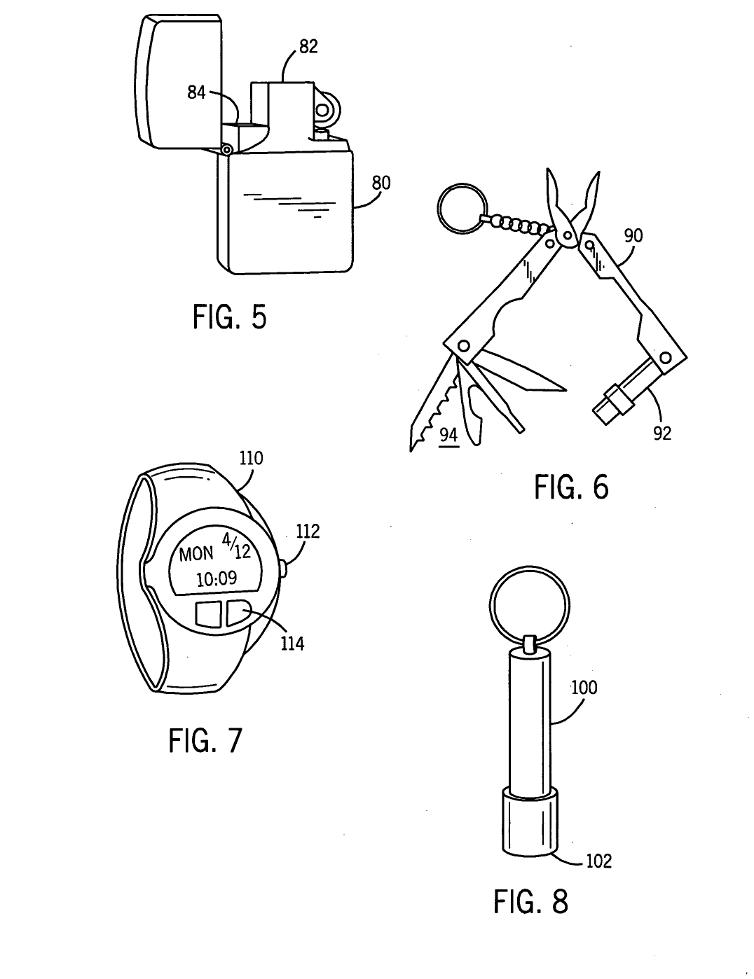

The portable utility device can be packaged in numerous shapes and forms with many different secondary utilities or functions. In FIG. 5, the portable utility device is shown as lighter 80 with integrated tuner having stroboscopic light source 82. The stroboscopic light 82, as integrated in lighter 80, is used to tune musical instruments as described above. Lighter 80 includes control buttons, display, and electronic tuner components such as shown in FIG. 4. The control buttons and display may be positioned on any convenient and accessible surface of lighter 80. In addition, lighter 80 has a secondary utility or function of generating a small flame from exhaust port 84 for lighting tobacco products, candles, and fireplaces. The stroboscopic tuner is convenient, accessible, and will be readily available when needed because it is integrated with a device having secondary utility, separate and apart from the instrument tuning function. Because of its secondary utility, lighter 80 with integrated stroboscopic tuner will likely be with the user at times when the stringed instrument needs tuning, independent of the activity associated with the musical instrument.

In FIG. 6, the portable utility device is shown as utility tool 90 with integrated tuner having stroboscopic light source 92. Again, the stroboscopic light 92, as integrated in utility tool 90, is used to tune musical instruments. Utility tool 90 includes control buttons and electronic tuner components such as shown in FIG. 4. The control buttons and display may be positioned on any convenient and accessible surface of utility tool 90. In addition, utility tool 90 has the secondary utility features 94 such as pliers, file, knife, screwdriver, bottle opener, and key chain. The stroboscopic tuner will be readily available when needed because it is integrated with a device having secondary utility, separate and apart from the musical instrument and tuning function.

In FIG. 7, the portable utility device is shown as watch or timepiece 110 with integrated tuner having stroboscopic light source 112. Watch 110 is shown in the form of a wristwatch having a display or face for the present time and day readings. The tuning function is displayed on the face of watch 110 in addition to, or in lieu of, the time and day readings. Control buttons 114 can be used to set the watch and/or to control the integrated tuner. The stroboscopic light source 112 can be directed at the strings while the artist is wearing watch 110. The electronic tuner circuit 30 is integrated within watch 110. Watch 110 typically includes a crystal oscillator for controlling the time keeping function. Although the time-keeping crystal oscillator may be used for the tuning function, an alternate design choice will have a separate crystal oscillator 66 as shown in FIG. 4 for the tuning function.

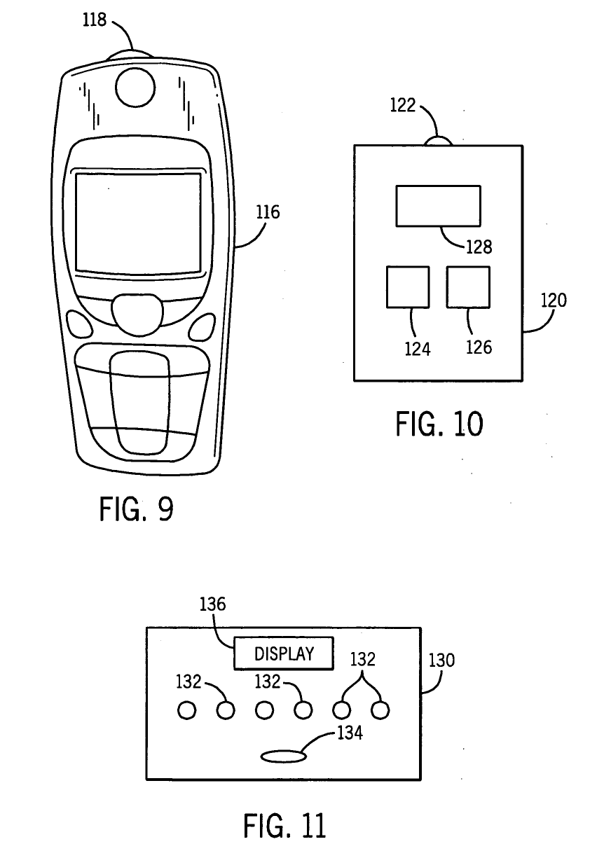

In FIG. 8, the portable utility device is shown as pin light 100 with integrated tuner having stroboscopic light source 102. In FIG. 9, the portable utility device is shown as cell phone or pager 116 with integrated tuner having stroboscopic light source 118. In other embodiments, the portable utility device can be in the form of a key chain fob, necklace, jewelry, belt clip, etc. In each case, the stroboscopic tuner, as integrated in the portable utility device, is used to tune musical instruments. The portable utility device includes control buttons, display, and electronic tuner components such as shown in FIG. 4. The control buttons and display may be positioned on any convenient and accessible surface of the utility device. In addition, the portable utility device has secondary utility features, e.g., pin light 100 generates light in low-light settings, cell phone 116 allows the user to stay in voice communication with others, etc. The stroboscopic tuner will be readily available when needed because it is integrated with a device having secondary utility separate and apart from the instrument tuning function. Because of its secondary utility, the portable utility device with integrated tuner having a stroboscopic light source is convenient, accessible, and will likely be with the user at times when the stringed instrument needs tuning, independent of the activity associated with the musical instrument.

Turning to FIG. 10, a plastic card 120 is shown as the utility device. The plastic card may function as a credit card, personal identification, picture holder, or other information storage device. Card 120 is thin and conveniently fits into a purse or wallet. Card 120 includes an integrated tuner with stroboscopic light source 122. Again, the stroboscopic tuner 122, as integrated in plastic card 120, is used to tune musical instruments as described above. Card 120 has electronic tuner components such as shown in FIG. 4 and control buttons 124 and 126 for selecting and enabling the strobe frequency. The strobe frequency is displayed on display 128. Card 120 is held in hand and the strobe light source is directed onto the strings 14 to adjust the string tension and tune guitar 12 as described above.

In FIG. 11, another plastic card 130 is shown as the utility device. The plastic card may function as a credit card, personal identification, picture holder, or other information storage device. Card 130 is thin and conveniently fits into a purse or wallet. Card 130 includes an integrated tuner having multiple stroboscopic light sources 132. Card 130 further includes microphone or audio pickup 134.

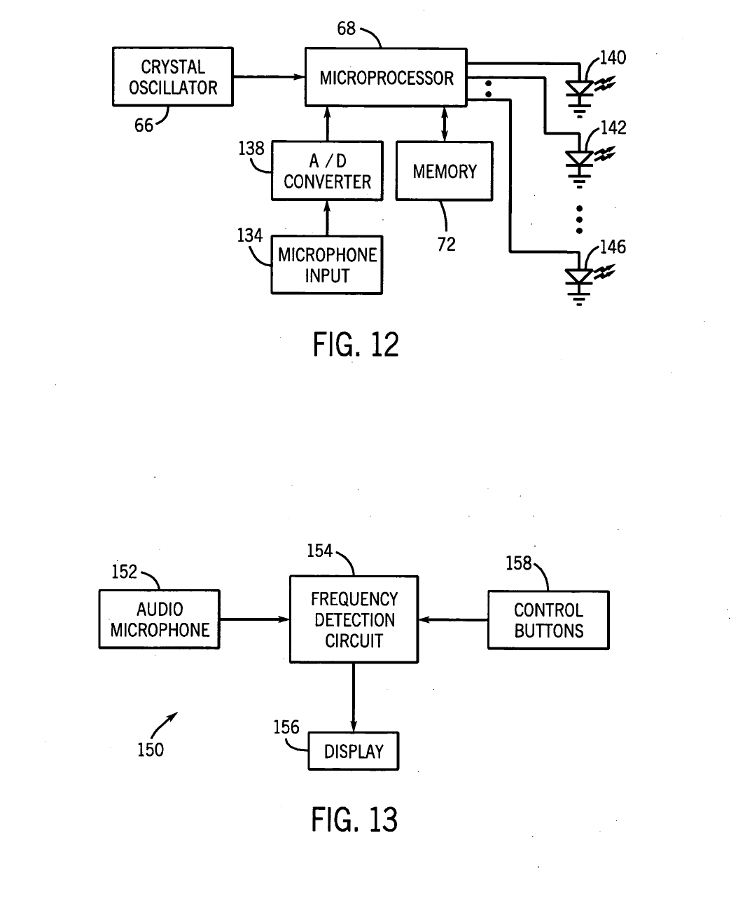

The stroboscopic tuner, as integrated in plastic card 130, is shown in FIG. 12. Components having a similar function are assigned the same reference numbers used in FIG. 4. The microphone input 134 picks up sound waves from strings 50-60. The analog sound waves are converted to digital signals by analog to digital converter 138. The digital signals are processed through microprocessor 68 to enable one or more of six LEDs 140, 142, through 146. LEDs 140-146 correspond to the six stroboscopic light sources 132.

Card 130 is placed under guitar strings 50-60 and aligned so that stroboscopic light sources 132 are under each string 14. The back of card 130 has a rough or tacky surface to hold the card in a fixed position under strings 50-60. When the artist plucks one of strings 50-60, the sound is picked up by microphone 134 and converted to digital signals for processing by microprocessor 68. Microprocessor 68 detects the fundamental frequency represented by the received digital signal and determines the closest ideal strobe frequency to the received frequency. Microprocessor 68 enables the corresponding one of the LEDs 140-146 having the ideal strobe frequency that is closest to the fundamental frequency of the received digital signal. Display 136 will provide frequency and control status information back to the user.

The artist plucks any string 50-60 and the LED under that string illuminates because the string, although out-of-tune, still resonates at a fundamental frequency closest to the ideal resonant frequency for that string. The artist adjusts the machine head 22 until the string remains motionless under the strobe light. The artist does not have to press any control buttons to select the strobe frequency. If the wrong strobe light turns on, the string may be substantially out-of-tune. The string tension should be adjusted to get the string close to its correct base resonant frequency so that the tuner can select the proper strobe frequency, i.e., the LED under the string.

FIG. 13 describes an alternate tuner 150 using audio signal processing. Audio tuner 150 receives audio signals from guitar 12. Audio microphone 152 picks up the sounds from strings 50-60. Frequency detection circuit 154 utilizes a counter or other frequency detection techniques to convert the audio signal to a received fundamental frequency. The received fundamental frequency is displayed on display 156. The artist plucks a string and the given resonant frequency is displayed on display 156. The machine head 22 is adjusted until the designed base resonant frequency is shown on display 156. Tuner 150 may include control buttons 158 to allow the artist to select the desired or intended resonant frequency, similar to control button 34 described above. Frequency detection circuit 154 compares the frequency of the received audio signal to the desired resonant frequency. When the frequency of the received audio signal matches the desired resonant frequency then display 152 indicates the guitar string is properly tuned. Display 152 can be any type of visual or audible indicator. Display 152 may be an indicator light or an audible sound. Display 152 may use a line or bank of LEDs, with the center LED corresponding to an in-tune condition. The LEDs to the left and right of the center LED are varying or progressively greater degrees of mismatch between frequency of the received audio signal and the desired resonant frequency.

Audio tuner 150 may be integrated into any and all of the utility devices described in FIGS. 2 and 5-11. Moreover, the tuning function can be performed on any type of musical instrument that emits audible sounds including string instruments, keyboards, horns, percussion, etc. The utility device thus integrates any type of musical instrument tuner. The tuner is convenient, accessible, and will be readily available when needed because it is integrated with a device having secondary utility, separate and apart from the instrument tuning function. Because of its secondary utility, the utility device with integrated string tuner will likely be with the user at times when the stringed instrument needs tuning, independent of the activity associated with the musical instrument.

A person skilled in the art will recognize that changes can be made in form and detail, and equivalents may be substituted for elements of the invention without departing from the scope and spirit of the invention. The present description is therefore considered in all respects to be illustrative and not restrictive, the scope of the invention being determined by the following claims and their equivalents as supported by the above disclosure and drawings.

1. A tuning device for a musical instrument, comprising:
a tuner having a programmable stroboscopic light source adapted for tuning a musical instrument;
a control button on the tuner for programming a state of the stroboscopic light source; and
a utility device integrated with the tuner, wherein the utility device has a secondary function which is independent of the tuning activity associated with the musical instrument.

2. The tuning device of claim 1, wherein the tuner includes a control button for enabling the stroboscopic light source.

3. The tuning device of claim 1, wherein the tuner includes a display for indicating a state of the stroboscopic light source.

4. The tuning device of claim 1, wherein the tuner has a tear-drop shape.

5. The tuning device of claim 1, wherein the utility device is a key ring, lighter, utility tool, pin light, jewelry, cell phone, card, or watch.

6. A musical instrument tuning device, comprising:
a tuner; and
a utility device integrated with the tuner, wherein the utility device has a secondary function apart from the musical instrument.

7. The musical instrument tuning device of claim 6, wherein the tuner includes a controllable strobe light.

8. The musical instrument tuning device of claim 7, wherein the tuner includes a control button for controlling the strobe light.

9. The musical instrument tuning device of claim 7, wherein the tuner includes a control button for enabling the strobe light.

10. The musical instrument tuning device of claim 6, wherein the tuner includes a display for indicating a state of the strobe light.

11. The musical instrument tuning device of claim 6, wherein the tuner has a tear-drop shape.

12. The musical instrument tuning device of claim 6, wherein the utility device is a key ring, lighter, utility tool, pin light, jewelry, cell phone, card, or watch.

13. A tuning device, comprising:
a controllable strobe light; and
a utility device integrated with the controllable strobe light, wherein the utility device has a secondary function apart from the controllable strobe light.

14. The tuning device of claim 13, further including a control button for controlling the strobe light.

15. The tuning device of claim 13, further including a control button for enabling the strobe light.

16. The tuning device of claim 13, further including a display for indicating a state of the strobe light.

17. The tuning device of claim 13, wherein the strobe light is encased in a tear-drop shaped housing.

18. The tuning device of claim 13, wherein the utility device is a key ring, lighter, utility tool, pin light, cell phone, card, or watch.

19. A method of making a portable musical instrument tuner, comprising:
providing a tuner; and
providing a utility device integrated with the tuner, wherein the utility device has a secondary function apart from the tuner.

20. The method of claim 19, wherein the tuner includes a strobe light source.

21. The method of claim 20, further including controlling the strobe light source with a control button.

22. The method of claim 20, further including enabling the strobe light with a control button.

23. The method of claim 20, further including displaying a state of the strobe light.

24. The method of claim 20, wherein the utility device is a key ring, lighter, utility tool, pin light, jewelry, cell phone, or watch.

25. A utility device, comprising:
a musical instrument tuner; and
a utility device integrated with the musical instrument tuner, wherein the utility device has a secondary function apart from the instrument tuner.

26. The utility device of claim 25, wherein the musical instrument tuner includes a controllable strobe light.

27. The utility device of claim 25, wherein the musical instrument tuner includes a plurality of controllable strobe lights.

28. The utility device of claim 25, wherein the musical instrument tuner includes an audio microphone for picking up sounds.

29. The utility device of claim 25, wherein the musical instrument tuner converts audio signals to a frequency indicator.

30. The utility device of claim 25, wherein the musical instrument tuner includes a control button for controlling the tuning function.

31. The utility device of claim 25, wherein the musical instrument tuner includes a display for indicating a state of the tuning function.

32. The utility device of claim 25, wherein the utility device is a key ring, lighter, utility tool, pin light, jewelry, cell phone, card, or watch.

33. A musical instrument tuner, comprising a card having an integrated tuner, wherein the integrated tuner includes a control circuit housed within the card for enabling the integrated tuner.

34. The musical instrument tuner of claim 33, wherein the integrated tuner has at least one controllable strobe light.

35. The musical instrument tuner of claim 33, wherein the integrated tuner has a plurality of controllable strobe lights.

36. The musical instrument tuner of claim 33, further including an audio microphone for picking up sounds.

37. The musical instrument tuner of claim 33, wherein the integrated tuner includes a control button for controlling the tuning function.

38. The musical instrument tuner of claim 33, wherein the integrated tuner includes a display for indicating a state of the tuning function.

39. A time keeping device, comprising a musical instrument tuner integrated within the time keeping device.

40. The time keeping device of claim 39, wherein the musical instrument tuner includes a controllable strobe light.

41. The time keeping device of claim 39, wherein the musical instrument tuner includes a control button for controlling the tuning function.

42. The time keeping device of claim 39, wherein the musical instrument tuner includes a display for indicating a state of the tuning function.

43. The time keeping device of claim 40, wherein the musical instrument tuner is incorporated within a wristwatch.
